(19) United States
(12) Patent Application Publication
(10) Pub. No.: US 2026/0361782 A1
(43) Pub. Date: Nov. 12, 2026

(54) Remote Content Rendering In Video Conferences Based On Content Metadata

(71) Applicant: Zoom Communications, Inc., San Jose, CA (US)

(72) Inventors: Juntao Feng, Hangzhou (CN); Tianqi Kong, Hangzhou (CN); Chong Lv, Hangzhou (CN); Jiezheng Yang, Hangzhou (CN); Xingguo Zhu, Hangzhou (CN)

(21) Appl. No.: 19/205,324

(22) Filed: May 12, 2025

(51) Int. Cl. H04L 65/80; H04L 65/403

(52) U.S. Cl. CPC H04L 65/80; H04L 65/403

(57) ABSTRACT

A receiving conferencing application on a computing device receives content metadata from a sending conferencing application during a video conference. The content metadata is associated with content rendered by a content application on a presenter device and shared in the video conference. The receiving conferencing application obtains the content based on the content metadata and locally renders the content on the computing device using the content metadata.

### FIELD

This disclosure generally relates to video conferences, and, more specifically, to content sharing in video conferences using content metadata.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 illustrates a block diagram of a system for facilitating content sharing in a video conference using metadata-based synchronization.

FIGS. 6A-6B illustrate examples of bridging mechanisms usable for generating content metadata, such as the content metadata of FIG. 5.

FIG. 7A is an example of a user interface associated with a conferencing application.

FIG. 7B is an example of a user interface associated with a receiving conferencing application, such as the receiving conferencing application of the viewing device in FIG. 5.

FIGS. 8A-8B is an example of an interaction diagram of document sharing in video conferences using content metadata.

FIG. 9 is a flowchart of an example of a technique for document sharing in video conferences using content metadata.

FIG. 10 is a flowchart of another example of a technique for document sharing in video conferences using content metadata.

FIG. 11 is a flowchart of another example of a technique for document sharing in video conferences using content metadata.

FIG. 12 is a flowchart of an example of a technique for generating and providing content metadata to facilitate document sharing in a video conference.

FIG. 13 is a flowchart of another example of a technique for facilitating content sharing in a video conference by rendering content and managing metadata.

FIG. 14 is a flowchart of an example of a technique for local rendering of shared content in a video conference based on received metadata.

### DETAILED DESCRIPTION

Conferencing software is frequently used across various industries to support video-enabled conferences between participants in multiple locations. In some cases, each of the conference participants separately connects to the conferencing software from their own remote locations. In other cases, one or more of the conference participants may be physically located in and connect to the conferencing software from a conference room or similar physical space (e.g., in an office setting) while other conference participants connect to the conferencing software from one or more remote locations. Conferencing software thus enables people to conduct video conferences without requiring them to be physically present with one another. Conferencing software may be available as a standalone software product or it may be integrated within a software platform, such as a unified communications as a service (UCaaS) platform.

A technical challenge in video conferencing arises when participants share and collaborate on content (e.g., documents or whiteboards) during meetings, particularly under varying network conditions. Current video conferencing platforms typically offer content sharing capabilities that rely on transmitting video streams of the shared content, which consume substantial bandwidth. When network connectivity degrades, the quality of shared content often becomes compromised, resulting in pixelated, delayed, or completely unreadable content for remote participants.

The consequences of this technical limitation are significant. For example, when a presenter shares browser-based documents or desktop applications via generic screen-sharing, the conferencing application (implemented on the presenter's computing device) transmits to receiving conferencing applications (implemented on computing devices of other participants) only a pixel-based feed, with no contextual understanding of the content's identity (e.g., source location) or state (e.g., scroll position). This approach fails to adapt to dynamic changes, such as scrolling, and cannot disambiguate multiple open documents, forcing receivers to depend entirely on the video stream's quality. Under poor network conditions, this leads to inconsistent user experiences, reduced meeting productivity, and increased resource demands, as platforms must sustain high-bandwidth streams to compensate. Without a scalable solution to extract and leverage content metadata in these scenarios, current video conferencing systems fall short of delivering seamless, high-quality content sharing across diverse network environments.

Implementations according to this disclosure address problems such as these by enabling seamless content sharing in video conferencing through a bridging mechanism between two applications: a content application and a conferencing application. The content application generates content metadata about the view state of a shared document. In response to a trigger (e.g., degraded network performance), the conferencing application obtains the content metadata via a bridging mechanism from the content application and transmits the content metadata to viewing devices, which use the content metadata to obtain the document and locally mirror the view state of the presenter.

The implementations of this disclosure represent a technical improvement in the decoupling of content sharing from network-intensive video feeds, addressing scalability and usability challenges in prior technologies. The content application independently manages content display and content metadata generation, while the conferencing application orchestrates distribution, minimizing server-side overhead. For instance, as a presenter scrolls in the content application, updated content metadata (e.g., a new scroll position) is bridged instantly via the bridging mechanism, allowing remote content applications to mirror the change. This distributed architecture mitigates latency and pixelation, automating synchronization for a scalable, efficient advancement over traditional methods reliant on user intervention or specialized modes.

As used herein, a “content application” refers to a computer-implemented software application that renders and manages digital content shareable in a video conference. Content applications include, but are not limited to: (1) web browsers displaying cloud-hosted documents, slideshow presentations, or interactive whiteboards; (2) native desktop applications such as word processors, spreadsheet applications, or presentation software; and (3) specialized collaborative tools such as diagram creation tools with simultaneous editing capabilities, virtual canvas environments that enable spatial organization of content, and project management platforms with integrated document viewing and markup features. A content application is capable of generating content metadata. A content application may natively generate content metadata or may be enhanced with custom code or extensions that enable content metadata generation capabilities.

The “conferencing application” oversees the video meeting and participant connectivity. This technical advancement optimizes content delivery by, for example, embedding “content metadata” within the content application's rendered output, allowing the conferencing application to extract and distribute this content metadata as a lightweight data packet rather than relying on high-bandwidth video streams, ensuring robust synchronization under poor network conditions.

A bridging mechanism is a technical communication channel established between the content application and the conferencing application to enable the transfer of content metadata for identifying and synchronizing shared content. Implementing the bridging mechanism involves configuring a structured pathway through which metadata flows, resulting in a persistent conduit that facilitates ongoing information exchange. The bridging mechanism is used to adapt content sharing dynamically.

In one configuration, the content application embeds content metadata into a visual element using encoding and data hiding techniques like steganography, which the conferencing application captures via periodic screen output analysis and extracts. Alternatively, where direct integration is feasible, the content application transmits content metadata to the conferencing application through a programmatic channel (e.g., WebSocket or native messaging). The conferencing application then sends this content metadata-such as a uniform resource locator (URL) or binary string-to receiving conferencing applications. A receiving conferencing application uses the received content metadata to locally render the document from its source.

This configurable approach reduces bandwidth demands and enhances real-time collaboration, surpassing conventional systems that are reliant on generic screen-sharing.

Throughout this disclosure, the terms “document” and “content” are used interchangeably to refer to any viewable, reviewable, or editable material that can be shared in a video conference. This includes, but is not limited to, word processing documents, spreadsheets, slideshow presentations, whiteboards, web pages, diagrams, images, and other collaborative materials. Both terms encompass any information rendered (e.g., displayed or output) by a content application that can be shared via a conferencing application, regardless of format, structure, or persistence characteristics. This interchangeable usage reflects the broad applicability of the metadata-based synchronization techniques described to diverse types of shareable materials.

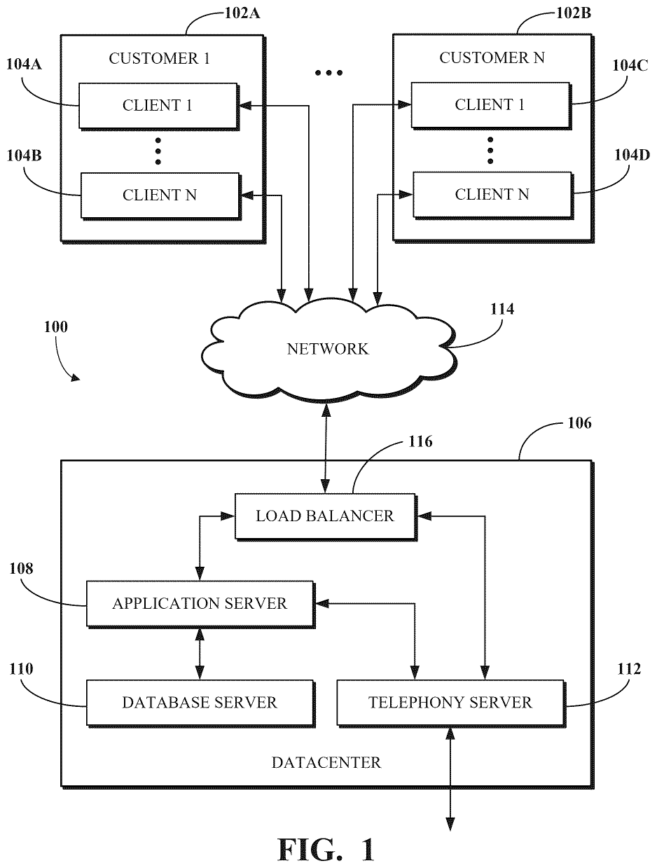

To describe some implementations in greater detail, reference is first made to examples of hardware and software structures used to implement a system for content sharing in video conferences using content metadata to enable local rendering of the content. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, an SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, an SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

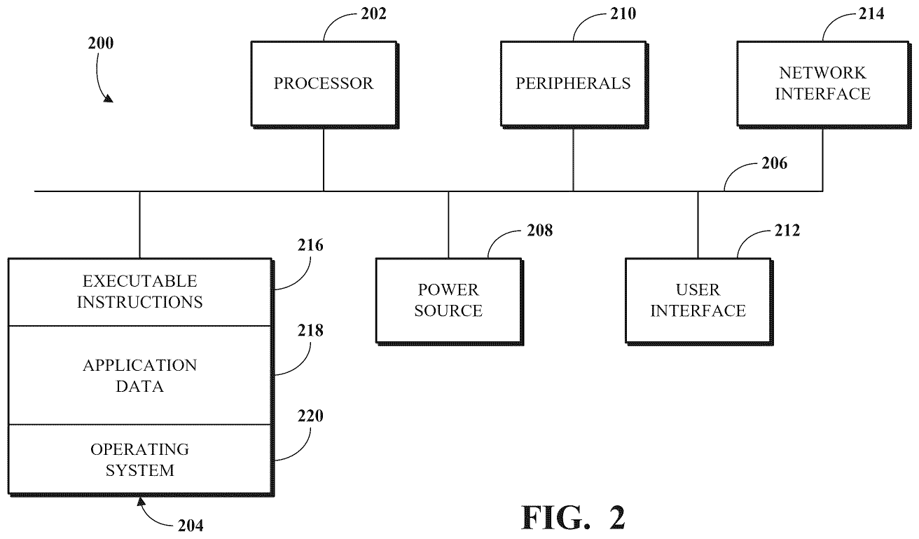

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

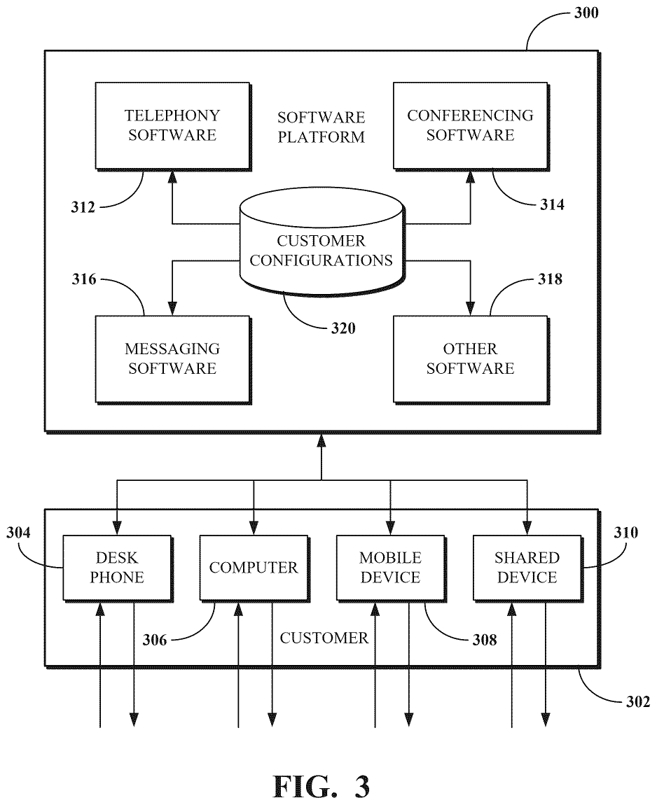

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software that facilitates content sharing in video conferences using content metadata to enable local rendering of the content. In some such cases, the conferencing software 314 can include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

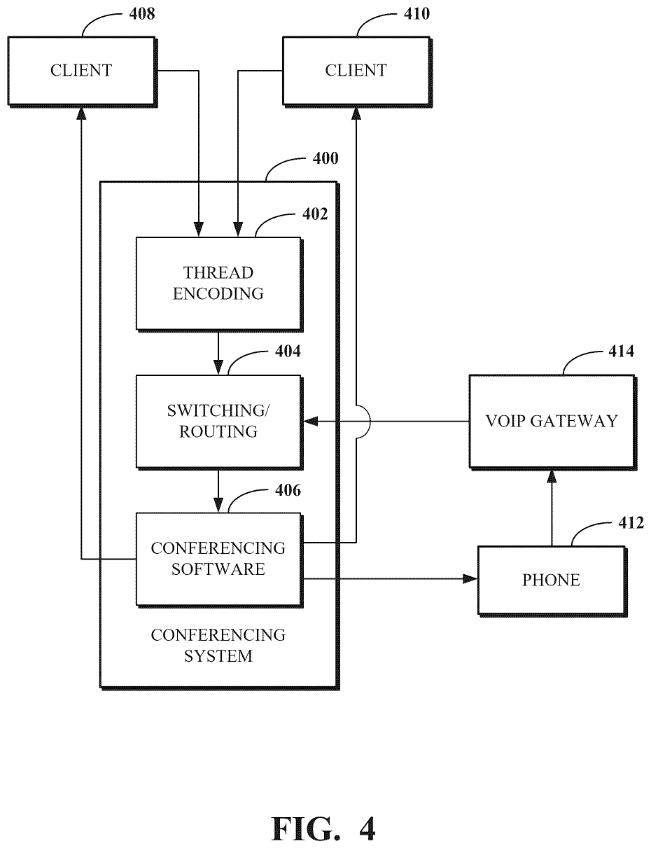

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and arranged in a center position of the conferencing software user interface while the user interface tiles for other conference participants are reduced in size and arranged near an edge of the conferencing software user interface. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant access the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 directs the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video stream for any portion of the conference. In some cases, however, the conference may have video disabled, such as where each participant connects to the conference using a phone rather than a client, or where a host of the conference selectively configures the conference to exclude video functionality.

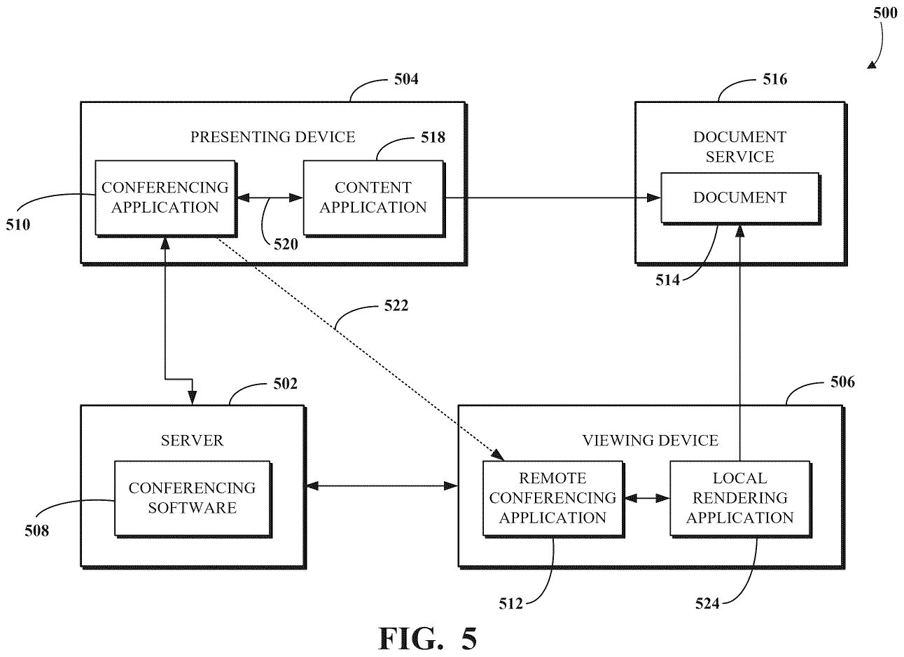

FIG. 5 illustrates a block diagram of a system 500 for facilitating content sharing in a video conference using metadata-based synchronization. The system 500 includes a server 502 and two participant devices connected to the video conference: a presenting device 504 and a viewing device 506. The presenting device 504 and viewing device 506 establish respective connections to the video conference hosted or enabled by conferencing software 508 operating on the server 502, which may function as a conferencing server to mediate metadata and content exchange.

Although only two participant devices are shown in FIG. 5, the system 500 can accommodate a significantly larger number of devices, potentially supporting multiple concurrent video conferences hosted by the server 502. The roles of devices within this system may be interchangeable-for example, a viewing device (e.g., the viewing device 506) can also be a presenting device (e.g., the presenting device 504) with respect to content shared by another device, and vice versa. The presenting device 504 includes a conferencing application 510 and a content application 518, while the viewing device 506 includes a receiving conferencing application 512 and a local rendering application 524. The presenting device 504 and the viewing device 506 can be one of the clients 408 or 410 of FIG. 4 or a computing device, such as the computing device 200 of FIG. 2.

FIG. 5 illustrates a scenario where a presenting participant associated with the presenting device 504 shares a document rendered (e.g., by the content application 518) on a display of the presenting device 504 with other conference participants. For example, the presenting participant may open a document 514 from the document service 516. The document 514 is displayed at a display of the presenting device 504 via a content application 518. That is, the content application 518 displays content of the document 514. The presenting participant may then perform an application share, a window share, or a screen share via the conferencing application 510 with the other conference participants. As described herein, a video stream of the shared screen portion (e.g., the application, window, or entire screen) is transmitted from the presenting device 504 to other participant devices (e.g., the viewing device 506) via the conferencing software 508.

The document 514, which can be any viewable, reviewable, or editable content (e.g., a word processing document, spreadsheet, slideshow presentation, or whiteboard), is managed by the document service 516, which may be a cloud-based service. The document service 516 may implement access control to grant permissions to authorized users, ensuring that only participants with appropriate access rights, such as read or edit permissions, can retrieve or modify the document 514 during the video conference. The document 514 is accessed by the presenting device 504 from the document service 516, typically via a URL.

In response to network degradations (e.g., detection of network degradations) that may compromise the quality of the video stream received at the viewing device 506, or in response to some other trigger, the system 500 enables the viewing device 506 to locally render and view the document 514 and synchronize the view of the document 514 between the viewing device 506 and the presenting device 504 without reliance on the degraded video stream. Synchronizing the view of the document 514 can include aligning the display state across devices, such as matching the scroll position to reflect the same portion of the document visible on the presenting device 504, adjusting the zoom level to mirror the magnification applied at the presenting device, and the like, thereby maintaining a consistent and real-time collaborative experience despite varying network conditions.

To enable the viewing device 506 to locally render and synchronize the view of the document 514 with the presenting device 504, the conferencing application 510 obtains, via a bridging mechanism 520, content metadata 522 associated with the rendering of the document 514. The conferencing application 510 may transmit the content metadata 522 as side information within a data packet, independent of the video stream, either directly from the presenting device 504 to the viewing device 506 or via the conferencing software 508 of the server 502. Dynamic updates to the content metadata 522 may occur periodically (e.g., every 1-2 seconds) to reflect changes such as scroll positions, zoom levels, page navigation, and other view state modifications, thereby enabling real-time synchronization between the presenting device 504 and the viewing device 506 with respect to the rendering of the document 514 without requiring continuous video transmission, thereby enabling a seamless collaborative experience despite potential network degradation.

The content application 518 on the presenting device 504 is configured to render the document 514 for display and generate (e.g., facilitate or enable the generation of) the content metadata 522, which may include structured data such as a URL and view state (e.g., scroll position, zoom level), to facilitate sharing in the video conference. The content application 518 may include or interact with the bridging mechanism 520 to generate and provide the content metadata 522 to the conferencing application 510. Depending on the type and format of the document 514, the content application 518 can take various forms. The content application 518 can be a generic off-the-shelf application supplemented with additional executable instructions that facilitate the generation of the content metadata 522. For example, the content application 518 may be a web browser with injected executable code (e.g., JavaScript instructions), a web browser with a browser extension, or a native application (e.g., Microsoft® Office application) with custom add-ins.

The local rendering application 524 on the viewing device 506 is configured to respond to rendering commands from the receiving conferencing application 512 based on the content metadata 522, such as adjusting scroll positions or zoom levels to synchronize the document's view with the presenting device 504. The local rendering application 524 may be implemented as a container under the control of the receiving conferencing application 512, such as an inline frame (iframe), a panel, a tab, or a Web View, embedded within the user interface of the receiving conferencing application 512, enabling programmatic control to render the document 514 directly and to manage its lifecycle, such as closing the container when the video conference ends.

As used herein, “content metadata” refers to structured data that facilitates the sharing and synchronization of a document view in the video conference, enabling local rendering on a viewing device, such as the viewing device 506, to mirror the presenter's display (e.g., the presenter's view state of the document 514). The content metadata 522 may be referred to as synchronization metadata, sharing metadata, document view state metadata, or document synchronization metadata, and may be or include view state metadata, encompassing data such as a URL for accessing the document from a document service, such as the document service 516, as well as view state information like scroll position, zoom level, or other attributes relevant to the document's presentation state, such as slide number or cell range. The purpose of the content metadata 522 is to provide a lightweight, adaptable mechanism for the conferencing application 510 to extract this data via the bridging mechanism 520 for transmission to the viewing device 506 thereby, for example, decoupling display sharing from high-bandwidth video streams and supporting real-time collaboration across diverse network conditions. An illustrative example of content metadata may be {“url”: “https://acme.us/docs/12345”, “scrollPosition”: 1200}, detailing the content's location and view state (e.g., presentation state).

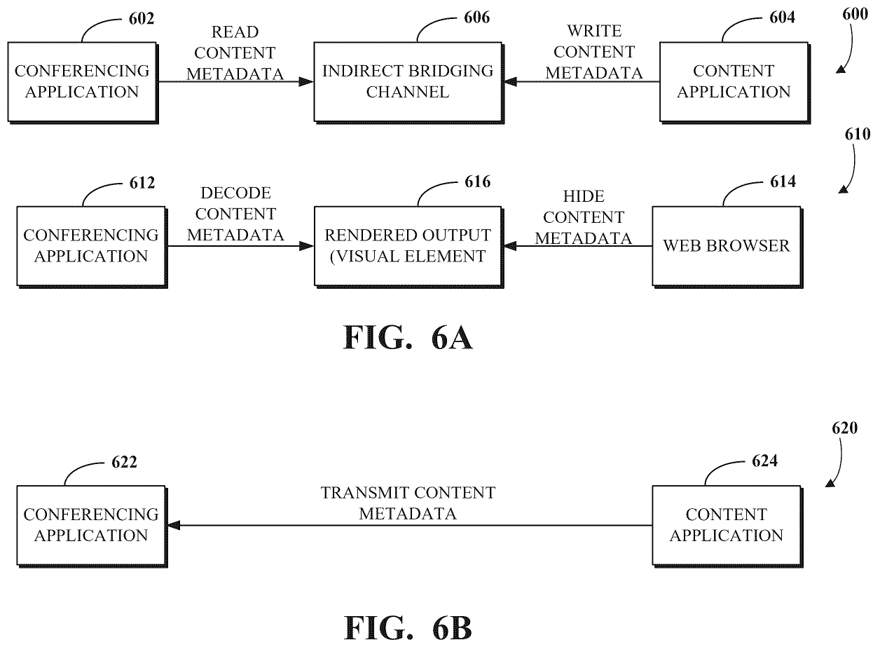

FIGS. 6A-6B illustrate examples of bridging mechanisms usable for generating content metadata, such as the content metadata 522 of FIG. 5. As already mentioned, a bridging mechanism, such as the bridging mechanism 520 of FIG. 5, is a technical communication channel employed to facilitate the (direct or indirect) transfer of content metadata from a content application, such as the content application 518 of FIG. 5, to a conferencing application, such as the conferencing application 510 of FIG. 5, within a video conference system. A bridging mechanism may be classified as either “direct” or “indirect” based on the communication pathway employed. A direct bridging mechanism establishes programmatic communication channels between applications, while an indirect bridging mechanism relies on intermediary data representations without requiring direct invocation between applications.

The need for such a bridging mechanism arises because the conferencing application, which manages the video conference and coordinates content sharing with viewing devices, such as the viewing device 506 of FIG. 5, lacks inherent awareness of the specific (e.g., identity of) content being rendered and shared by the content application. Without a bridging mechanism to inform the conferencing application of this content (such as its source, view state, or other relevant attributes), the conferencing application would be unable to obtain and effectively communicate this information to the viewing device 506, thereby precluding the viewing device from locally rendering and synchronizing the shared document, such as the document 514 of FIG. 5, in a manner that mitigates reliance on high-bandwidth video streams.

The diversity of bridging mechanisms is necessitated by the varying architectures and operational constraints of different types of content applications that may be employed. For instance, a content application implemented as a web browser, which operates within a sandboxed environment to enhance security, may impose restrictions on direct interaction with external processes, such as the conferencing application 510, thereby requiring indirect transfer methods to convey content metadata 522. In contrast, a native application, such as a desktop word processing program with custom add-ins, may support more direct communication channels due to its lack of sandboxing, enabling alternative bridging approaches.

FIG. 6A illustrates an indirect bridging mechanism 600 and an example bridging mechanism 610 thereof, which are employed to facilitate the transfer of content metadata within the system 500 of FIG. 5. The indirect bridging mechanism 600 represents a technical communication channel whereby a content application, such as the content application 518 of the presenting device 504 in FIG. 5, provides content metadata, analogous to the content metadata 522, to a conferencing application, such as the conferencing application 510 of the presenting device 504, without direct invocation. In some implementations, and due to technical limitations, the conferencing application 602 may not be able to directly communicate with the content application 518 necessitating an indirect communication channel therebetween.

The indirect bridging mechanism 600 includes a conferencing application 602 and a content application 604, which can be the conferencing application 510 and the content application 518 of FIG. 5. An indirect bridging channel 606 serves (e.g., can be used) as an intermediary for content metadata transfer. The indirect bridging channel 606 enables the conferencing application 602 to read content metadata left (e.g., written or created) by the content application 604. The indirect nature of the indirect bridging mechanism 600 ensures that the conferencing application 602 does not need to directly call into the content application 604, or vice versa, aligning with a leave-and-read paradigm discussed for the bridging mechanism 520.

In some implementations, the indirect bridging channel 606 provides a passive transfer mechanism tailored to the architecture of the system 500 and content application type. The indirect bridging channel 606 may be a shared memory, an event-driven notification system that triggers metadata availability, or a visual embedding technique where the content application 518 embeds metadata into a rendered output for the conferencing application 510 to extract.

Shared memory refers to a designated memory space accessible by both the content application 518 and the conferencing application 510, allowing the content application 518 to write metadata for the conferencing application 510 to read without direct invocation.

The example bridging mechanism 610 provides a specific instantiation of the indirect bridging mechanism 600 that implements visual embedding, where the content application may be implemented as a web browser. The conferencing application 612 corresponds to the content application 518 of FIG. 5 when configured as a web browser, potentially enhanced with a browser extension or injected code to generate the content metadata.

The web browser 614 is configured for rendering the document 514 and hiding content metadata within a rendered output 616. The rendered output may include a visual element, such as an image region within the document 514. The content metadata can be hidden in the visual element, meaning it is not perceptible by a human, ensuring seamless integration without altering the visual appearance. Various techniques can be employed for hiding the content metadata in the visual element, including steganography, which embeds data imperceptibly by modifying pixel values, and digital watermarking, which encodes data in a manner resistant to removal.

An example of a steganography technique usable for embedding the content metadata within the visual element is Least Significant Bit (LSB) steganography. In a typical 24-bit color image, each pixel is represented by three 8-bit values corresponding to the red, green, and blue (RGB) channels, and the LSB of at least one of the channels can be modified without perceptibly altering the visual appearance of the image. For instance, an original 8-bit pixel value of 10110110 (decimal 182) remains unchanged if embedding a 0 bit, or becomes 10110111 (decimal 183) if embedding a 1 bit, resulting in a nearly imperceptible change. To embed the content metadata, such as a URL or view state, the content application converts the metadata into a bitstream and replaces the LSBs of sequential pixels in an image region of the rendered output with these bits, transforming the original image (cover image) into a stego-image that remains visually unchanged to the human eye. As further described herein, the content metadata can be extracted by capturing a screenshot of the stego-image, retrieving the LSBs from the pixel values, reconstructing the bitstream, and decoding the hidden metadata.

The content metadata can be hidden in multiple formats, such as a structured data string, a binary sequence, or a Quick Response (QR) code visually integrated into the visual element. For example, the content metadata may be converted into a QR code, and then the QR code may be hidden via LSB steganography into the visual element. The content application 518 modifies or updates the hidden data in response to changes in the document's view state, such as scrolling or zooming, ensuring the metadata reflects the current display state. The conferencing application 612, corresponding to the conferencing application 510 of FIG. 5, captures screenshots of the rendered output 616 and analyzes the visual element to decode or read the content metadata, enabling the leave-and-read approach of the indirect bridging channel 606.

In certain implementations, the conferencing application 612 initiates the capture of screenshots in response to an identified trigger. Such triggers may include degraded network conditions detected at the viewing device 506, the presenting device 504, or upon receiving a request from the viewing device 506 for the content metadata 522. For example, a conference participant associated with the viewing device 506 may specifically indicate a desire for a “local follow along” experience, prompting the conferencing application 612 to begin screenshot capture and metadata extraction to facilitate local rendering and synchronization.

FIG. 6B illustrates a direct bridging mechanism 620, which can be employed to facilitate the transfer of content metadata within the system 500 of FIG. 5. The direct bridging mechanism 620 represents a technical communication channel whereby a conferencing application 622, such as the conferencing application 510 of the presenting device 504 in FIG. 5, actively communicates with a content application 624, such as the content application 518, to obtain content metadata, such as the content metadata 522. Unlike the indirect approach, where metadata is left for passive extraction, the direct bridging mechanism 620 involves the conferencing application 622 (corresponding to 510) calling into, requesting, or receiving data directly from the content application 624, enabling a more immediate and controlled transfer of metadata to support local rendering and synchronization at a viewing device, such as the viewing device 506 of FIG. 5.

In this context, “direct” refers to a communication paradigm where an active interface can be established between the conferencing application 622 and the content application 624, transmitting content metadata through a dedicated channel rather than relying on the content application to embed or leave the data in a rendered output. This direct interaction enables the conferencing application 622 to request and/or receive the content metadata in real-time, facilitating dynamic updates. The direct bridging mechanism 620 provides a framework that can be implemented using various communication protocols, each suited to different technical environments within the video conference system.

In some implementations, the WebSocket communication mechanism may be used. WebSocket is a persistent, bidirectional communication protocol that can be used to enable real-time data exchange between the conferencing application 622 and the content application 624. The conferencing application 622 and the content application 624 must support network socket capabilities, with the content application 624, which can be a web browser with an extension or a native application, configured to establish a WebSocket connection. The conferencing application 622 may host or connect to a WebSocket server, typically on the same device. This configuration can be particularly effective when the content application 624 operates in a sandboxed environment with extension support, where limitations such as restricted direct inter-process communication, constrained file system access, and the need for a native messaging host to bridge external interactions are mitigated through the use of extensions to facilitate metadata transmission.

In some implementations, native interfaces can be used. Native interfaces involve inter-process communication (IPC) techniques such as pipes, sockets, or native messaging protocols. In an example, the conferencing application 622 can be configured to call directly into the content application 624, requiring both applications to be implemented as native processes or to include a native messaging host that bridges a sandboxed application, such as a web browser, to the conferencing application 622.

Native interfaces are technically possible when the content application 624 is a native application (e.g., Microsoft Office with add-ins), which can directly use operating system-supported IPC mechanisms (e.g., pipes or sockets) to communicate with the conferencing application 622, or when the content application 624 is a browser-based application with an extension that pairs with a native messaging host. In the latter case, the browser extension transmits metadata to the native host via a browser-supported messaging protocol (e.g., Google Chrome Native Messaging), and the native host, as a standalone executable, enables the conferencing application 622 to invoke specific functions or retrieve metadata through an IPC channel, such as named pipes or local sockets, provided the operating system supports these mechanisms.

To illustrate, using Chrome Native Messaging, a browser extension may send a JSON message to a native host registered as com. example. conference host. For example, the extension may invoke chrome.runtime.sendNativeMessage(“com.example.conference_host”, {“metadata”: {“url”: “https://docs.example.com/doc123”, “scrollPosition”: 1500}}) to transmit content metadata identifying a document's source and current scroll position. The native host, running as a local process, receives this message via stdin as a length-prefixed JSON string, parses it to extract the metadata, and forwards it to the conferencing application 622 over a named pipe (e.g., \\.\pipe\conference_pipe on Windows), enabling real-time synchronization of the document's scroll position during the video conference. Alternatively, the extension may use chrome.runtime.connectNative(“com.example.conference_host”) and/or the application programming interface (API) sentNativeMessage( ) to establish a persistent connection, enabling continuous metadata updates as the presenter navigates the document, with the native host relaying these updates to the conferencing application 622 via the same IPC channel.

To reiterate, the feasibility of direct communication mechanisms depends on the architectural compatibility between the conferencing application 622, the content application 624, and/or the operating system of the presenting device. For instance, the content application 624, implemented as a web browser-based application and operating within a sandbox, may require a native messaging host or a WebSocket bridge to enable direct calls, necessitating additional software components on the presenting device 504. In contrast, a content application 624 that is native, such as a word processing program, can support direct IPC without such intermediaries, provided the conferencing application 622 is configured to interface with the native application's API or communication endpoints, ensuring robust metadata transfer across diverse system configurations.

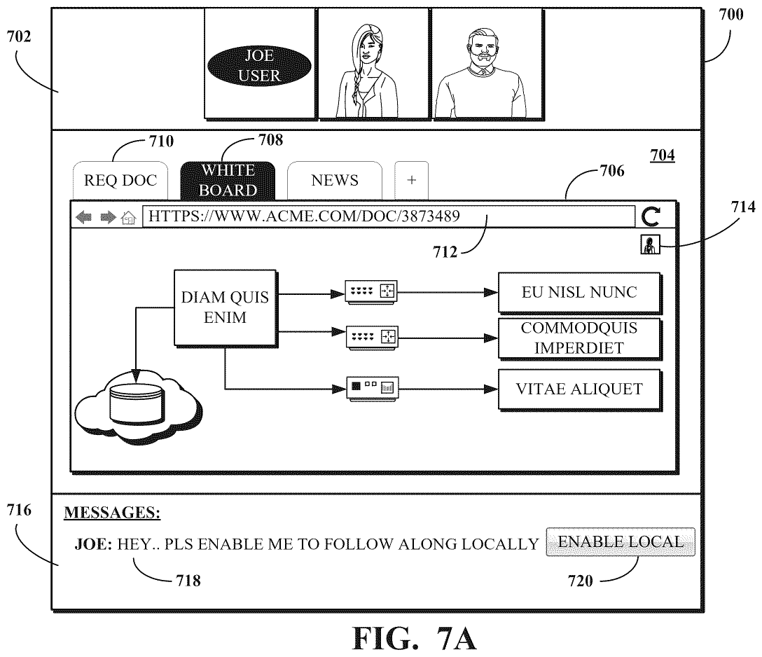

FIG. 7A is an example of a user interface 700 associated with a conferencing application. The user interface 700 may be displayed at a presenting device, such as the presenting device 504 of FIG. 5. The user interface 700 illustrates that a presenting participant associated with the presenting device is sharing content of their desktop in a video conference that includes the participants shown in a gallery 702 that includes, for at least some of the conference participants of the video conference, corresponding digital representations. A digital representation of a conference participant may be a label (e.g., a name), an image, a video stream obtained via a camera of the device of the conference participant, or some other digital representation.

On a desktop 704 is a content application 706 (which may be a web browser) that includes a tabbed interface, including tabs 708 and 710. The tab 708 is the currently active tab. Thus, the contents of the tab 708 are shown (e.g., shared to) the other conference participants. The presenting user may switch to the tab 710 at any point in time. In this case, the tab 708 shows a whiteboard (which may be the document 514 of FIG. 5) that may be retrieved from a document service that manages shared whiteboards. The user interface 700 illustrates that the whiteboard is retrieved from the location shown in an address bar 712. The document service includes, and the content application 706 shows, visual elements associated with users currently viewing the whiteboard. Thus, as shown in the user interface 700, the document (e.g., the whiteboard) includes a visual element 714, showing the identity of the presenting participant.

The content application 706 updates and includes content metadata within the visual element 714, as described with the indirect bridging mechanism 600 of FIG. 6A. The content metadata is dependent upon the document type reflective of the specific characteristics of the shared content. Minimally, the content metadata includes the location (e.g., the URL) where the document may be accessed from, such as the address shown in the address bar 712. Additional metadata may be included depending on the type of the document. Broadly, the content metadata can be any data that enables a viewing participant to locally render a synchronized view that, to the extent possible, matches the presenting participant's display.

For example, with respect to a word processing document, a scroll location may be included to indicate the current position within the text; for whiteboards, a relative position or extents of the visual area (a viewport) and zoom level may be included to replicate the presenter's view; for a spreadsheet, cell range or cursor position might be added; and for slideshow presentations, slide number or animation state could be incorporated. This view state data can be used to ensure that the viewing participant's local rendering mirrors the presenting participant's perspective. The content application 706 hides the content metadata in the visual element 714 and regularly updates it based on changes in the viewport into the document, maintaining synchronization.

As described herein, the conferencing application regularly takes screenshots of at least the shared portion of the presenting participant's desktop, searches for the visual element 714, and decodes the content metadata from it. This process allows the conferencing application to extract and utilize the metadata for transmission to viewing devices.

In some implementation, a viewing participant, as shown in a chat area 716, may explicitly request that the content metadata be transmitted to their device for local viewing of the document, as demonstrated by a chat message 718. In response to the presenting user invoking a control 720, the conferencing application obtains and transmits the content metadata to the requesting viewing device, such as the viewing device 506 of FIG. 5.

FIG. 7B is an example of a user interface 750 associated with a receiving conferencing application, such as the receiving conferencing application 512 of the viewing device 506 in FIG. 5. The user interface 750 illustrates the experience of a viewing participant during a video conference where content, such as the whiteboard of FIG. 7A (e.g., the document 514 of FIG. 5), is shared by a presenting participant. The user interface 750 includes a gallery 752 that is similar to the gallery 702 of FIG. 7A.

The user interface 750 includes a local rendering of the document by a local rendering application 754, which corresponds to the local rendering application 524 of FIG. 5. The receiving conferencing application uses received content metadata to perform the local rendering. The content shown includes a whiteboard or document retrieved from the document service. The local rendering application 754 presents this content based on content metadata received from the presenting device, enabling the viewing participant to see a synchronized view matching the presenter's display.

The local rendering application 754 may be implemented or rendered as a container within the user interface 750, such as an inline frame (iframe), a Web View, or a panel, embedded under the control of the receiving conferencing application. This container approach enables the local rendering application 754 to seamlessly display the document 514 while enabling programmatic control, such as initiating or terminating rendering sessions, aligning with the system's flexibility as discussed in.

A status indicator 756 indicates that the viewing participant is currently benefiting from the local rendering and synchronization process. The status indicator 756 confirms that the local rendering application 754 is actively using the content metadata 522 to mirror, to the extent possible, the presenting device's viewport, such as scroll position or zoom level. The status indicator 756 provides visual feedback to the user, indicating the successful implementation of the metadata-based synchronization mechanism. In addition to the visual element 714 associated with the presenting participant, a visual element 758 is now shown by the local rendering application 754 since the viewing participant associated with the visual element 758 also has the whiteboard open.

A control 760, when activated, causes the receiving conferencing application to terminate the local rendering process and revert to transmitting the video stream, disabling the use of content metadata 522 for local rendering by the local rendering application 754. The control 760 enhances user flexibility, enabling the participant to revert to the default viewing experience if local rendering is no longer desired or if network conditions improve.

While the scenario described with respect to FIGS. 7A-7B indicates an explicit request for local rendering, the disclosure is not so limited, as described herein. The local rendering process may be automatically triggered in response to detecting network degradation at the presenting device 504 or one or more of the viewing devices 506, ensuring seamless adaptation to varying network conditions without user intervention.

The conferencing application may search for embedded metadata, such as the content metadata 522 of FIG. 5, only within the region of the screen selected for sharing by the presenting participant, thereby optimizing the metadata extraction process by focusing on the shared region as depicted in the user interface 700. Additionally, more than one document with embedded metadata may be visible within the shared screen region, allowing the conferencing application, such as the conferencing application 510 of FIG. 5, to detect multiple instances of content metadata corresponding to different documents. Accordingly, the conferencing application may transmit content metadata corresponding to more than one document to the viewing device, such as the viewing device 506 of FIG. 5, which may then open the multiple documents via one or more local rendering applications, such as the local rendering application 524 of FIG. 5, enabling synchronized viewing of all shared documents and enhancing collaborative flexibility across the video conference.

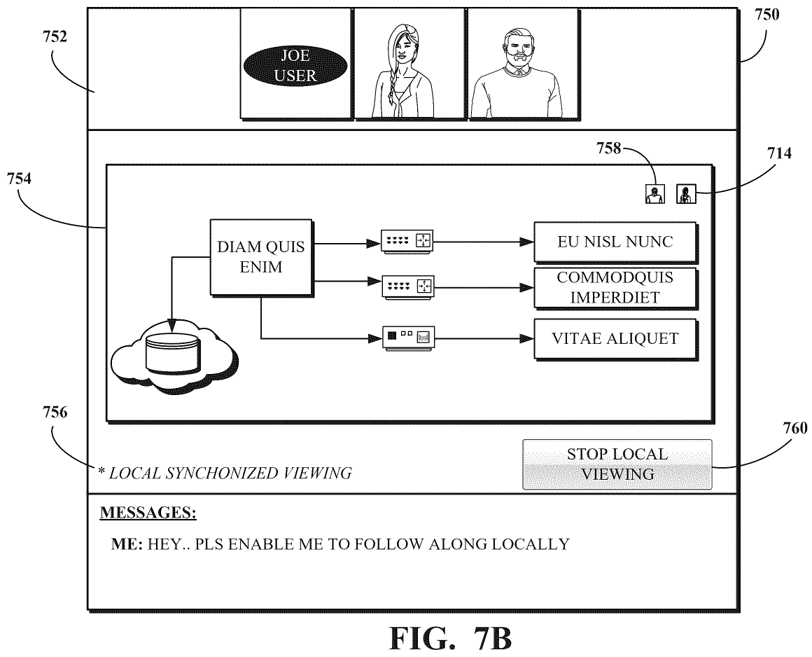

FIGS. 8A-8B is an example of an interaction diagram 800 of document sharing in video conferences using content metadata. The interaction diagram 800 illustrates the indirect bridging mechanism described above. The interaction diagram 800 includes a conferencing application 802, a content application 804, a receiving conferencing application 806, a local rendering application 808, and a document service 810, which can be, respectively, the conferencing application 510, the content application 518, the receiving conferencing application 512, the local rendering application 524, and the document service 516 of FIG. 5. For brevity, a conferencing software, such as the conferencing software 508 of FIG. 5, is omitted from the interaction diagram 800. However, as can be appreciated by a person skilled in the art, certain step or aspects of the interaction diagram 800 can be facilitated by the conferencing software.

At 812, the content application 804 requests a document from the document service 810 using a URL. For example, the content application 518 shown in FIG. 5 may request the document 514 from the document service 516, typically via a URL, to initiate content sharing in a video conference. In some implementations, this request may be initiated in response to a user selecting a document from a list of documents or similar user interface element within the content application. In other implementations, the conferencing application 802 may request the document directly from the document service 810, with the content application 804 facilitating the rendering of the document once it has been obtained.

At 814, the document service 810 returns document content to the content application 804. For example, the document service 516 shown in FIG. 5 may provide the document 514 to the content application 518, enabling rendering on the presenting device 504. In some implementations, the document content may include the entire document file. In alternative implementations, the document content may include only a portion of the document, such as metadata or a reference to the document location, with additional content being streamed as needed. The document service 810 may, in some implementations, verify access rights before returning the document content, ensuring that the requesting user has appropriate permissions to view or share the document.

At 816, the content application 804 renders the document with content metadata. For example, the content application 518 shown in FIG. 5 may display the document 514 on a user's screen and simultaneously embed content metadata 522 within the rendered output. In some implementations, as described in connection with FIG. 6A, this metadata may be embedded using steganographic techniques that hide the data within visual elements of the document without altering its appearance to human viewers. The content metadata may include, but is not limited to, the document's URL or location identifier, current scroll position, zoom level, or page number. In alternative implementations, the content metadata may also include information about annotations, cursor position, or selection state. The content metadata embedding process may be natively implemented by the content application 804 or through extensions, plugins, or injected code that enhances the content application's capabilities.

At 818, the conferencing application 802 transmits a video stream of the screen share to the receiving conferencing application 806. For example, the conferencing application 510 shown in FIG. 5 may capture the portion of the screen selected for sharing by the presenting participant and displaying the document and transmit it as a video stream through the conferencing software 508 to remote participants. In some implementations, this video stream may be transmitted at various quality levels depending on network conditions, as described in connection with FIG. 4. The conferencing application 802 transmits the video stream of the screen share to a server, such as the server 502 of FIG. 5, which delivers it to the receiving conferencing application 806.

At 820, the content application 804 continuously updates the content metadata. For example, as a user scrolls, zooms, or otherwise navigates within the document using the content application 518 shown in FIG. 5, the content application may dynamically update the embedded metadata to reflect the current view state. In some implementations, this update process may occur at regular intervals, such as every 1-2 seconds. In alternative implementations, the updates may be triggered by specific events, such as when the user completes a scroll action or changes pages. The continuous updating of metadata ensures that the current state of the document view is always encoded within the visual representation being shared.

At 822, a trigger to initiate transmission of the content metadata, such as the content metadata 522 of FIG. 5, to one or more receiving conferencing applications, including the receiving conferencing application 806, may be received. For example, the trigger may be received based on the server 502 or the conferencing application 802 detecting network degradation, which may prompt the conferencing application 802 to begin content metadata sharing with (e.g., transmission to) the receiving conferencing application 806. The trigger may be received from a particular viewing device that includes the receiving conferencing application 806, in response to detecting network degradation at that viewing device or as an explicit request from a viewing participant. In an example, the explicit request may be received as described with respect to a chat message 718 in the user interface 700 of FIG. 7A. Additionally, the trigger may be received based on the conferencing application 802 detecting network degradation at the presenting device 504 of FIG. 5. In some implementations, the trigger may be received based on an automated decision by the server 502 or conferencing application 802, which may evaluate bandwidth optimization policies or predetermined thresholds for video quality to determine the need for metadata transmission.

At 824, the conferencing application 802 captures a screenshot of the shared content. For example, the conferencing application 510 shown in FIG. 5 may capture a screenshot of the rendered output (e.g., a screenshot of the shared region of the display) to extract the content metadata, as described with respect to the indirect bridging mechanism 600 of FIG. 6A.

At 826, the conferencing application 802 extracts content metadata from the screenshot. For example, the conferencing application 802 may decode the content metadata from a visual element (e.g., steganography, as in FIG. 6A) and send it as a data packet to at least the receiving conferencing application 806. In some implementations, the extraction process may involve identifying specific visual markers that indicate where metadata is embedded, or it may use digital watermarking techniques to recover data encoded in ways imperceptible to human viewers but detectable through computational analysis. In other implementations, the extraction may employ QR reading algorithms to decode metadata embedded as a QR code, or use machine learning algorithms to identify metadata patterns within the screenshot.

At 828, the conferencing application 802 transmits the content metadata to the receiving conferencing application 806. The content metadata may be transmitted via a conferencing software, such as the conferencing software 508 of FIG. 5, to the receiving conferencing application 806. In some implementations, the conferencing software may determine which viewing devices to transmit the content metadata based on factors such as network conditions identified with respect to each of the viewing devices, or multicast groups therewith optimizing resource allocation across the video conference. In some implementations, the content metadata may be transmitted in formats like JSON or a compressed binary string, using TCP for reliable delivery or UDP for low-latency transmission, and may be encrypted to ensure security. If extraction fails, the conferencing application may retry by capturing additional screenshots or revert to transmitting the video stream, ensuring uninterrupted sharing.

At 830 of FIG. 8B, the receiving conferencing application 806 requests the document from the document service 810 using the URL from the content metadata. In some implementations, this request may include authentication credentials to verify the viewing participant's access rights. In some implementations, the document request may specify only the portions of the document needed for immediate viewing based on the current view state information in the content metadata.

At 832, the document service 810 returns the document content to the receiving conferencing application 806. For example, the document service 516 shown in FIG. 5 may provide the document 514 to the receiving conferencing application 512 for local rendering. In some implementations, the document service may verify that the viewing participant has appropriate access rights before returning the document. In some implementations, the document service may return a restricted version of the document based on the viewing participant's permissions.

At 834, the receiving conferencing application 806 updates the local rendering application 808 with the new view state included in the content metadata. For example, the receiving conferencing application 512 shown in FIG. 5 may instruct the local rendering application 524 to adjust the display (e.g., scroll, zoom) of the document 514, thereby synchronization the local view of the document with the presenter's view. In an example, the document may be rendered locally in a container, which may be implemented as an iframe, Web View, or panel under the control of the receiving conferencing application 806. In alternative implementations, the local rendering application may be a separate window or tab managed by the receiving conferencing application.

An iterative block 836 illustrates that steps enclosed therein continue to be performed while the document is shared by the presenter. At 838, the content application 804 continuously updates the content metadata as the presenter's view state changes. For example, the content application 518 shown in FIG. 5 may update the content metadata 522 to reflect ongoing changes. In some implementations, this may be a continuous background process that occurs regardless of whether local rendering has been activated on viewing devices. In alternative implementations, the update frequency may increase when the it is detected that local rendering is active on one or more viewing devices.

At 840, the conferencing application 802 captures a new screenshot to reflect the updated content metadata. For example, the conferencing application 510 shown in FIG. 5 may periodically capture screenshots to extract updated metadata, as part of the indirect bridging mechanism 600 of FIG. 6A. In some implementations, the frequency of these captures may be adaptive, increasing when user interaction with the document is detected and decreasing during periods of inactivity to optimize resource usage.

At 842, the conferencing application 802 extracts the updated content metadata from the screenshot. For example, the conferencing application 510 shown in FIG. 5 may decode the updated content metadata from the visual element, ensuring the latest view state is available. In some implementations, this extraction process may compare newly extracted metadata with previously extracted metadata to identify only the changes, potentially optimizing subsequent data transmission.

At 844, the conferencing application 802 transmits the updated content metadata to the receiving conferencing application 806. In some implementations, only the changed portions of the metadata may be transmitted to minimize bandwidth usage. As such, if no portions are changed, then the content metadata may not be transmitted. In some implementations, complete metadata packages may be sent at regular intervals to ensure synchronization even if some updates are missed.

At 846, the receiving conferencing application 806 updates the local rendering application 808 with the new view state. For example, the receiving conferencing application 512 shown in FIG. 5 may instruct the local rendering application 524 to adjust the document 514's display (e.g., scroll, zoom), ensuring real-time synchronization with the presenter's view. In some implementations, this update may be applied immediately upon receipt of new metadata. In alternative implementations, the updates may be buffered and applied at regular intervals to provide a smooth viewing experience. The synchronization process may include additional interpolation or smoothing techniques to create natural-looking transitions between view states.

In some implementations, the interaction diagram 800 may include additional steps or alternative embodiments. For example, the content application 804 may use direct bridging, as described with respect to FIG. 6B, to transmit metadata directly to the conferencing application 802 via a programmatic channel like WebSocket, bypassing screenshot capture, as described herein. In some implementations, the trigger for local rendering, at 822, may be initiated by the server 502 detecting network degradation at the presenting device 504, rather than the viewing device 506.

The interaction diagram 800 may further include termination steps. In some implementations, the conferencing application 802 may end the sharing session, notifying the receiving conferencing application 806 via the server 502, which then instructs the local rendering application 808 to close. The local rendering application 808 is also closed if the viewing participant exists the conference. In alternative implementations, the viewing participant may manually disable local rendering using a control, such as the control 760 shown in FIG. 7B, reverting to the traditional video stream display without terminating the sharing session.

While not specifically shown in the interaction diagram 800, the interaction diagram 800, and the teachings herein, may include mechanisms for granting permissions to access the document, such as the document 514 of FIG. 5, to facilitate the sharing and local rendering process described herein. In some implementations, the conferencing software, such as the conferencing software 508 of FIG. 5, may keep track of temporary permissions granted to viewing devices, such as the viewing device 506 of FIG. 5, which may be automatically reversed when the sharing session ends, ensuring that access is revoked once collaboration ceases.

For example, the conferencing software may communicate with the document service to request temporary permissions for those viewing participants receiving the content metadata, allowing viewing devices to access the document for the duration of the sharing session. In some implementations, the presenting participant may manually assign permissions through the conferencing application, specifying which viewing participants or devices are authorized, potentially using predefined roles or access levels.

Additionally, the document service may implement a token-based system, where the conferencing software generates a temporary access token for each viewing device, which may expire after a set period or upon session termination, enhancing security and control. In some implementations, permissions may be dynamically adjusted based on network conditions or participant activity, allowing the conferencing software to grant or revoke access in real-time to optimize collaboration efficiency across diverse network environments.

While not specifically shown in the interaction diagram 800, transmission or receipt of the video stream of the shared content is selectively halted based on the detected trigger. For example, if a network issue, such as a packet loss rate exceeding a packet loss threshold (e.g., 5%) or bandwidth dropping below a bandwidth threshold (e.g., 1 Mbps), is identified at the presenting device 504, the conferencing application 802 ceases transmitting the video stream of the shared content entirely, relying solely on the content metadata transmitted at 828 and 844 to enable local rendering at the viewing device 506.

Similarly, if a network issue is identified at a specific viewing device, such as the viewing device 506 reporting degraded reception via a notification to the server 502, or if an explicit request is received from the specific viewing device (e.g., via a control similar to the control 760 in FIG. 7B), the conferencing software 508 does not transmit the video stream to that viewing device, instead delivering only the content metadata to facilitate local rendering, while continuing video stream transmission to other viewing devices with stable connections.

In another situation, if the server 502 detects a widespread network degradation affecting multiple viewing devices (e.g., a multicast group exceeding a latency threshold of 200 milliseconds), the conferencing software 508 may suspend video stream transmission across all affected devices, prioritizing content metadata distribution to maintain synchronization.

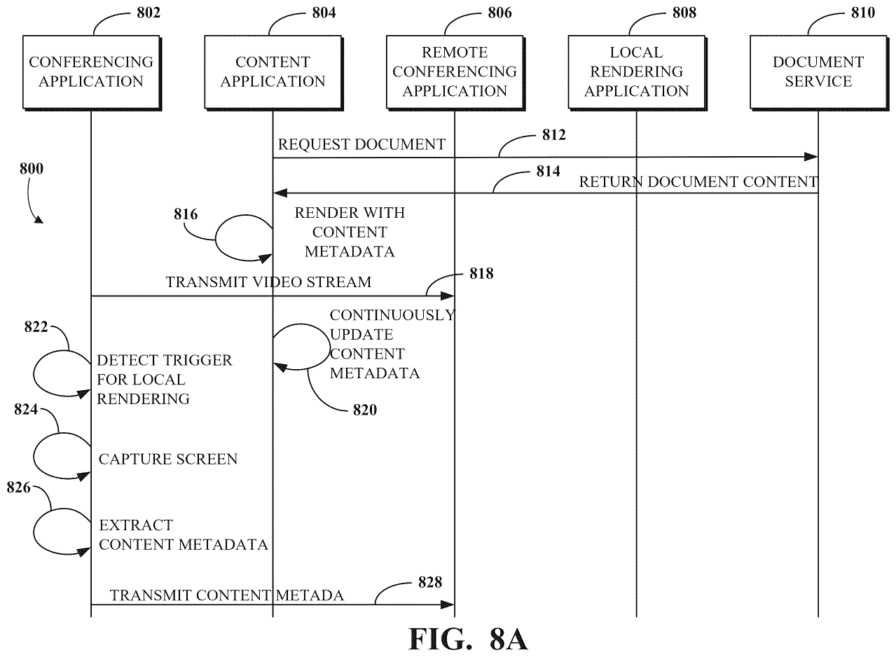

To further describe some implementations in greater detail, reference is next made to examples of techniques which may be performed by or using a system for document sharing in video conferences using content metadata. FIG. 9 is a flowchart of an example of a technique 900 for document sharing in video conferences using content metadata. The technique 900 can be executed using computing devices, such as the systems, hardware, and software described with respect to FIGS. 1-8B. The technique 900 can be implemented at or by a presenting device, such as one of the presenting device 504 of FIG. 5.

At 902, a conferencing application, implemented by the presenting device obtains content metadata from a content application that is also implemented at the presenting device. The content metadata is related to content (e.g., a document) rendered (e.g., output or displayed) by the content application and shared in a video conference by the conferencing application. For example, the presenting device may obtain the content metadata from the content application. In some implementations, the content metadata may include an identity of content rendered. The identity may include a URL identifying the source of the content. The content metadata may additionally include a view state of the content rendered by the content application. The view state may specify attributes such as scroll position or zoom level. The scroll position may indicate a current portion of the content being rendered by the content application. Obtaining the content metadata may involve different approaches depending.

In some implementations, obtaining the content metadata may include receiving the content metadata directly from the content application via a programmatic channel. For example, as described with respect to the direct bridging mechanism 620 shown in FIG. 6B, the conferencing application may establish a direct communication channel with the content application. In some implementations, the programmatic channel may be or include a WebSocket connection between the content application and the conferencing application to facilitate real-time data exchange.

In some implementations, communication between the content application and the conferencing application may occur via a native messaging protocol, and obtaining the content metadata may include receiving the content metadata through the native messaging protocol.

Native messaging protocols may leverage platform-specific optimization to enhance performance, particularly when both applications run as native processes on the same device. In some implementations, communication between the content application and the conferencing application may occur via an API exposed by the conferencing application, and obtaining the content metadata may include receiving the content metadata from the content application through the API.

In some implementations, obtaining the content metadata may include extracting the content metadata from a rendered output of the content application. For example, as described with respect to the indirect bridging mechanism 600 shown in FIG. 6A, the conferencing application may extract content metadata embedded in the visual output of the content application. In some implementations, extracting the content metadata may include capturing a screenshot of the content rendered by the content application, and analyzing the screenshot to detect and decode the content metadata embedded within the screenshot. As described herein, the content metadata may be embedded in a visual element of the rendered output, such as the visual element 714 shown in the user interface 700 of FIG. 7A.

In some implementations, the content application may insert the content metadata into the content by modifying pixel values of an image region within rendered content using an image steganography technique. For example, the content application 518 may imperceptibly alter pixel values in a designated region of the rendered content to encode the metadata. In some implementations, the image steganography technique may be or include LSB steganography, where the least significant bits of color channel values are modified to encode the content metadata without perceptibly affecting the appearance of the image.

In some implementations, the content application may insert the content metadata into the content by generating a QR code containing the content metadata and embedding the QR code into a visual element of rendered content. In some implementations, the content application may insert the content metadata into the content as a digital watermark, and obtaining the content metadata may include extracting the digital watermark from a rendered output of the content application.

In some implementations, the content (e.g., the content) may be at least one of a document, a whiteboard, or a slideshow presentation hosted in a cloud-based system, and the content metadata includes a uniform resource locator (URL) identifying the source of the content. The metadata may take the form of a lightweight data structure, such as a JSON object that captures both the content's identity and current view state. In some implementations, the content may include additional collaborative formats, such as spreadsheets with cell range metadata or interactive diagrams with cursor position data, expanding the range of shareable materials beyond traditional documents.

In some implementations, the content application may dynamically update the content metadata as the presenter modifies the view state. For example, if the presenter scrolls through a document, the content metadata may be refreshed to reflect the new scroll position, which can be embedded and extracted in real-time. In some embodiments, the conferencing application may periodically poll the content application for updates, or the content application may push updates only when significant changes occur, such as page transitions or zoom adjustments, to optimize processing overhead. Additionally, the technique 900 may support multiple content applications running simultaneously on the presenting device, each generating metadata for different shared windows, allowing the conferencing application to select and transmit metadata based on the active shared content.

At 904, the conferencing application transmits the content metadata to a receiving conferencing application during the video conference. The content metadata enables the receiving conferencing application to locally render the content from the source identified by the content metadata. For example, the presenting device may transmit the content metadata via the conferencing application to a receiving conferencing application, such as the receiving conferencing application 512 on the viewing device 506, enabling local rendering of the document 514.

In some implementations, the transmission of content metadata may be triggered by various conditions. One such condition may involve detecting, by the conferencing application, a network issue affecting video stream quality between the conferencing application and the receiving conferencing application, and transmitting the content metadata is performed in response to detecting the network issue. The detection may involve monitoring packet loss rates, bandwidth utilization, or frame drop counts that indicate degraded transmission quality.

In other implementations, the conferencing application may begin transmitting the content metadata in response to receiving, by the conferencing application, a notification from the receiving conferencing application indicating a network issue affecting video stream quality, and transmitting the content metadata is performed in response to receiving the notification. For example, the viewing device 506 may detect poor network conditions affecting its ability to receive high-quality video streams from the presenting device 504, and may notify the presenting device of this issue. In some implementations, the notification may include a request from the receiving conferencing application to initiate transmission of the content metadata.

In some implementations, transmitting the content metadata may include formatting the content metadata into a data packet to minimize bandwidth usage. The conferencing application may encrypt the metadata for security or use a multicast approach to send it to multiple receiving conferencing applications if multiple viewing devices are involved, enhancing scalability. In alternative embodiments, the technique 900 may include a buffering mechanism to retransmit the content metadata if delivery fails due to network interruptions, or it may prioritize transmission based on the severity of the network issue, ensuring that metadata reaches the remote device promptly. A conferencing software may mediate this transmission, coordinating with a server to manage delivery and temporary access permissions for the viewing device to retrieve the content.

The technique 900 may be extended to support diverse network conditions and user preferences. For instance, the conferencing application may integrate predictive analytics to anticipate network degradation based on historical data, initiating metadata transmission proactively before video quality declines significantly. In another variation, the receiving conferencing application may provide a user interface option to toggle between metadata-based local rendering and traditional video stream viewing, offering flexibility based on user choice or network recovery, similar to the control 760 shown in FIG. 7B. Additionally, the disclosure may accommodate hybrid scenarios where some viewing devices receive the video stream while others use local rendering, with the conferencing application dynamically adjusting the transmission method based on real-time network assessments.

The technique 900 may be adapted to support various collaborative environments and content types beyond the disclosed examples. For instance, the presenter or other viewing participants may annotate (e.g., write or draw on) the shared display. As such, the content metadata may also include additional attributes like drawing coordinates or playback positions so that the annotations can also be reproduced at the viewing device by the receiving conferencing application. The conferencing application may also interface with third-party cloud services to retrieve content, using authentication tokens embedded in the metadata to ensure secure access. In another variation, the technique may support offline mode, where the receiving conferencing application stores the last received metadata and content for later synchronization when the network reconnects.

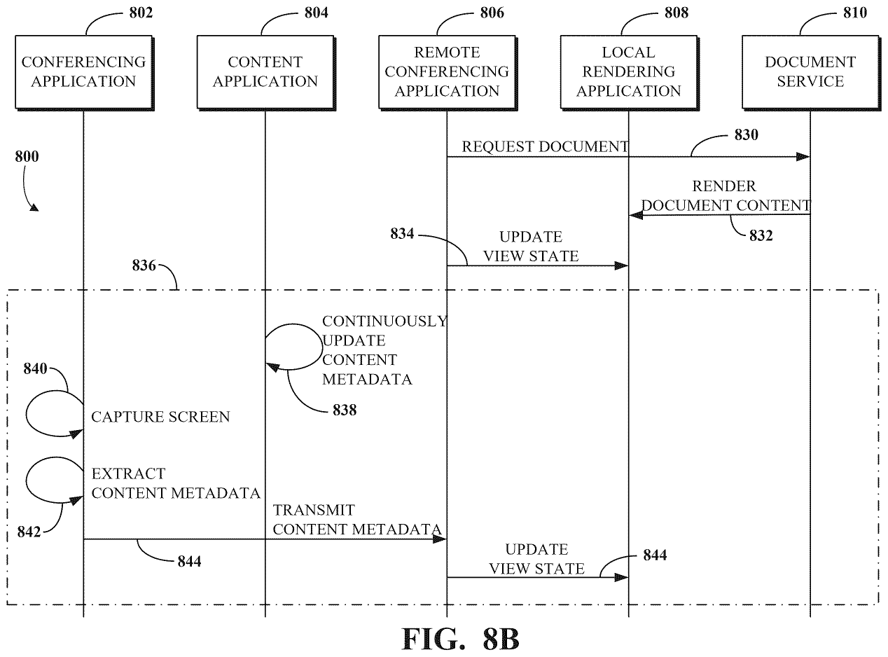

FIG. 10 is a flowchart of another example of a technique 1000 for document sharing in video conferences using content metadata. The technique 1000 can be executed using computing devices, such as the systems, hardware, and software described with respect to FIGS. 1-8B. The technique 1000 can be implemented at or by a presenting device, such as one of the presenting device 504 of FIG. 5.

At 1002, the technique 1000 includes generating content metadata associated with a document being shared in the video conference. For example, a content application (e.g., the content application 518 shown in FIG. 5) may generate content metadata for a document 514 that is being rendered for sharing in a video conference. The content metadata can be as described herein. As such, the content metadata may include a link to the document and a position indicator within the document.

At 1004, the technique 1000 includes embedding the content metadata into a visual element of (e.g., associated with) the document as rendered. For example, the content application (e.g., the content application 518 shown in FIG. 5) may embed the content metadata into a visual element of the rendered document, such as the visual element 714 shown in the user interface 700 of FIG. 7A. In some implementations, the content metadata may be embedded using steganography (e.g., LSB steganography).

At 1006, the technique 1000 includes capturing a screenshot of content rendered on a presenter device. For example, a conferencing application (e.g., the conferencing application 510 shown in FIG. 5) may capture a screenshot of the content rendered by the content application on the presenting device 504, as described herein. The screenshot capture may be triggered by various events, as described herein.

At 1008, the technique 1000 includes extracting the content metadata from the screenshot to obtain extracted content metadata. For example, the conferencing application (e.g., the conferencing application 510 shown in FIG. 5) may analyze the captured screenshot to detect and decode the content metadata embedded within it, as described herein. For example, when the content metadata is embedded using steganography, the extraction process may involve reversing the steganographic algorithm, such as analyzing the least significant bits of color values in designated pixels to reconstruct the encoded data. In alternative implementations, the conferencing application may employ computer vision techniques to locate visual elements likely to contain metadata, potentially using machine learning algorithms trained to identify regions of interest within the screenshot. If extraction fails, the conferencing application may attempt multiple screenshot captures or adjust processing parameters to improve the likelihood of successful metadata recovery.

At 1010, the technique 1000 includes transmitting the extracted content metadata to at least one receiver device. For example, the conferencing application (e.g., the conferencing application 510 shown in FIG. 5) may transmit the extracted content metadata to a receiving conferencing application on a viewing device

The technique 1000 may be implemented in a cyclical manner, with steps 1002 through 1010 repeated as the presenter navigates or modifies the shared document. For example, as the presenter scrolls through a document or changes zoom levels, the content application may generate updated metadata and embed it into the visual element. The conferencing application then captures new screenshots, extracts the updated metadata, and transmits these updates to viewing devices.

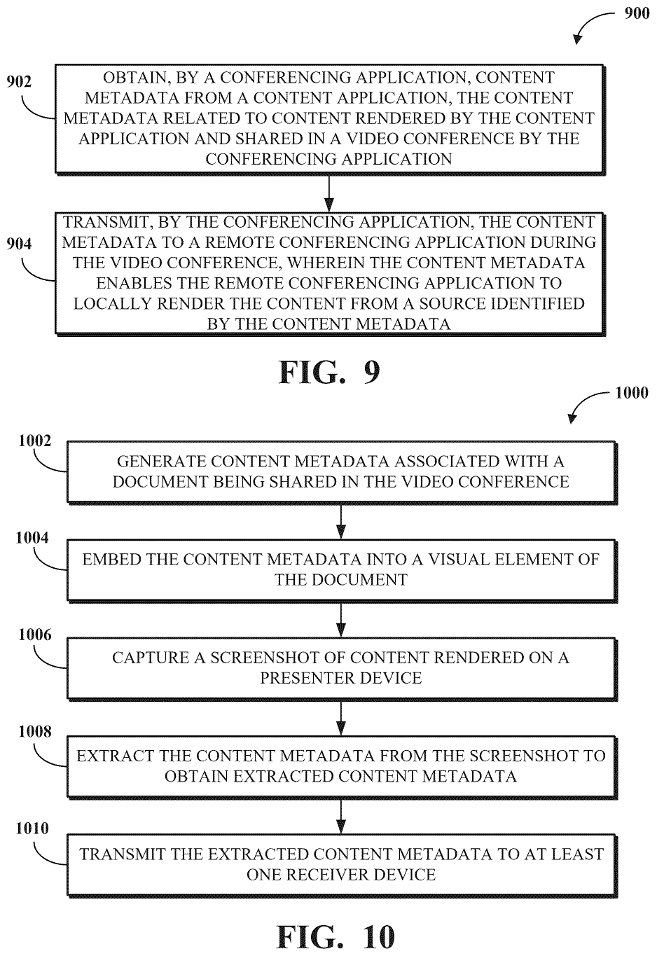

FIG. 11 is a flowchart of another example of a technique 1100 for document sharing in video conferences using content metadata. The technique 1100 can be executed using computing devices, such as the systems, hardware, and software described with respect to FIGS. 1-8B. The technique 1100 can be implemented at or by a presenting device, such as one of the presenting device 504 of FIG. 5.

At 1102, the technique 1100 includes monitoring at least a region of a display of a presenting device sharing a document in the video conference session. For example, a conferencing application (e.g., the conferencing application 510 shown in FIG. 5) may monitor a region of the display of the presenting device 504 where a document is being shared. At 1104, the technique 1100 includes generating a QR code containing content metadata for the document. For example, a content application (e.g., the content application 518 shown in FIG. 5) may generate a QR code that encodes content metadata, such as a URL identifying the document source and position parameters like scroll position or zoom level. At 1106, the technique 1100 includes embedding the QR code into an image element displayed in the document. For example, as described in connection with the example bridging mechanism 610 of FIG. 6A, the content application may embed the generated QR code into a visual element of the document, such as by incorporating it into a user interface element like the visual element 714 shown in FIG. 7A.

At 1108, the technique 1100 includes capturing a screenshot of the at least the region of the display of the presenting device. For example, the conferencing application 510 may capture a screenshot of the content rendered on the presenting device 504, similar to the screenshot capture process described in step 824 of FIG. 8A. At 1110, the technique 1100 includes scanning the screenshot to detect and decode the QR code. For example, the conferencing application may analyze the captured screenshot to locate and identify the embedded QR code. At 1112, the technique 1100 includes extracting the content metadata from the QR code. For example, the conferencing application may process the detected QR code to decode the content metadata contained within it, similar to the extraction process described in step 826 of FIG. 8A.

At 1114, the technique 1100 includes transmitting the content metadata to at least one participant device in the video conference session. For example, the conferencing application 510 may transmit the extracted content metadata to a receiving conferencing application on a viewing device, such as the receiving conferencing application 512 on the viewing device 506, as described in step 828 of FIG. 8A. In some implementations, the receiving conferencing application may use the received metadata to retrieve the document from its source and render it locally with the appropriate view parameters, enabling a synchronized view even under poor network conditions.

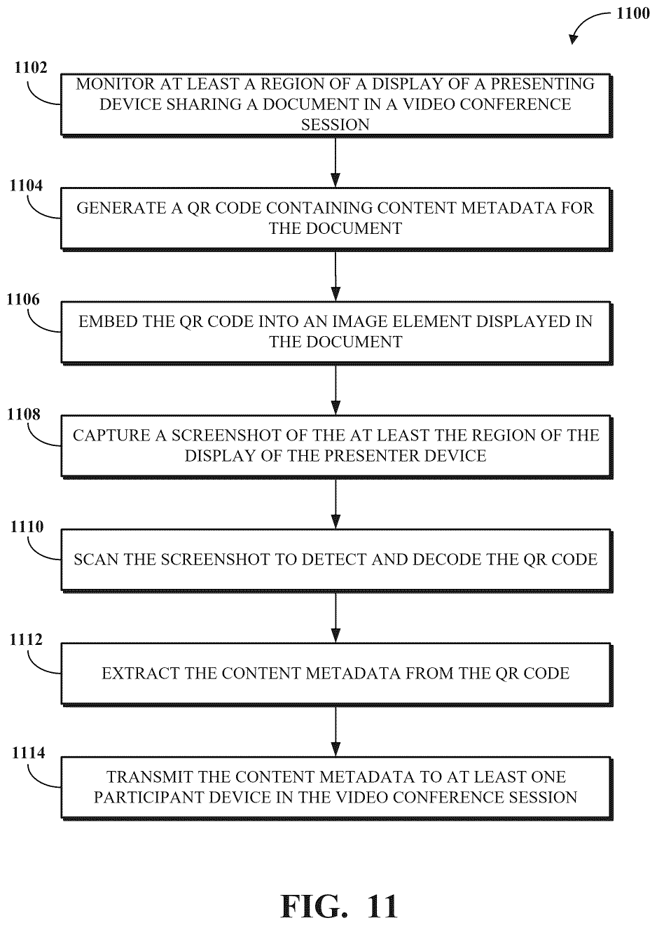

FIG. 12 is a flowchart of an example of a technique 1200 for generating and providing content metadata to facilitate document sharing in a video conference. The technique 1200 can be executed using computing devices, such as the systems, hardware, and software described with respect to FIGS. 1-8B. The technique 1200 can be implemented at or by a presenting device, such as one of the presenting device 504 of FIG. 5.

At 1202, the technique 1200 includes rendering content for display. The content being shared from the computing device in a video conference via (e.g., by) a conferencing application. For example, a content application (e.g., the content application 518 shown in FIG. 5) may render a document 514 for sharing in a video conference. In some implementations, the content may be, amongst others, a word processing document, a whiteboard, or a slideshow presentation hosted in a cloud-based system. As illustrated in the user interface 700 of FIG. 7A, the content application may be a web browser that displays content retrieved from a document service, such as a whiteboard visible in the currently active tab (e.g., the tab 708). The rendering process may involve displaying the content on a screen, with the content application managing its presentation state, such as scroll position or zoom level, to prepare it for sharing.

At 1204, the technique 1200 includes generating content metadata associated with the content. For example, the content application may generate content metadata that describes various attributes of the rendered content. In some implementations, the content metadata may comprise structured data identifying a source of the content, such as a URL. In other implementations, generating the content metadata may include determining a document identifier and a zoom level of the rendered content, providing information about both the content's identity and its current display state. Where the content application is a web browser, generating the content metadata may include executing a browser extension to extract the URL and a scroll position from the rendered content.

At 1206, the technique 1200 includes providing the content metadata to the conferencing application via a bridging mechanism of (e.g., implemented by) the content application. For example, the content application may provide the content metadata to the conferencing application via the bridging mechanism 520, as described in FIG. 5. In some implementations, the content metadata is provided to the conferencing application to enable a receiving conferencing application to locally render and synchronize the content without reliance on a high-bandwidth video stream of the content. As described, this approach reduces bandwidth demands by allowing the receiving conferencing application 512 to render the content locally from the source identified by the content metadata.

The bridging mechanism referenced may be implemented in various ways. In some implementations, providing the content metadata may include embedding the content metadata into a visual element of the rendered content. For example, as described in connection with the indirect bridging mechanism 600 of FIG. 6A, the content application may embed metadata in a rendered output 616 for later extraction by the conferencing application. The visual element may be or include a visual representation of an entity associated with the content, such as the visual element 714 in FIG. 7A, which shows the identity of the presenting participant. When embedding is used, various technical approaches may be employed, including modifying pixel values using steganography (claim 6), generating a QR code containing the metadata (claim 8), or encoding the metadata as a digital watermark.

In other implementations, the bridging mechanism may employ more direct communication channels. For example, providing the content metadata may comprise transmitting the content metadata to the conferencing application via a WebSocket connection, as described in connection with the direct bridging mechanism 620 of FIG. 6B. Alternative direct approaches may include sending the metadata through a native messaging protocol, which may utilize platform-specific optimizations for inter-process communication, or exposing an API that supports multiple concurrent requests.

The technique 1200 may include updating the content metadata in response to changes in the rendered content. For example, the content application may update the metadata when the presenter scrolls or zooms, with updates occurring in response to each scroll event that changes a view state, or periodically at a fixed interval. In some implementations, the content application may detect a change in the rendered content, such as a modification to a visible portion initiated by a user interaction, and update the metadata before providing it to the conferencing application.

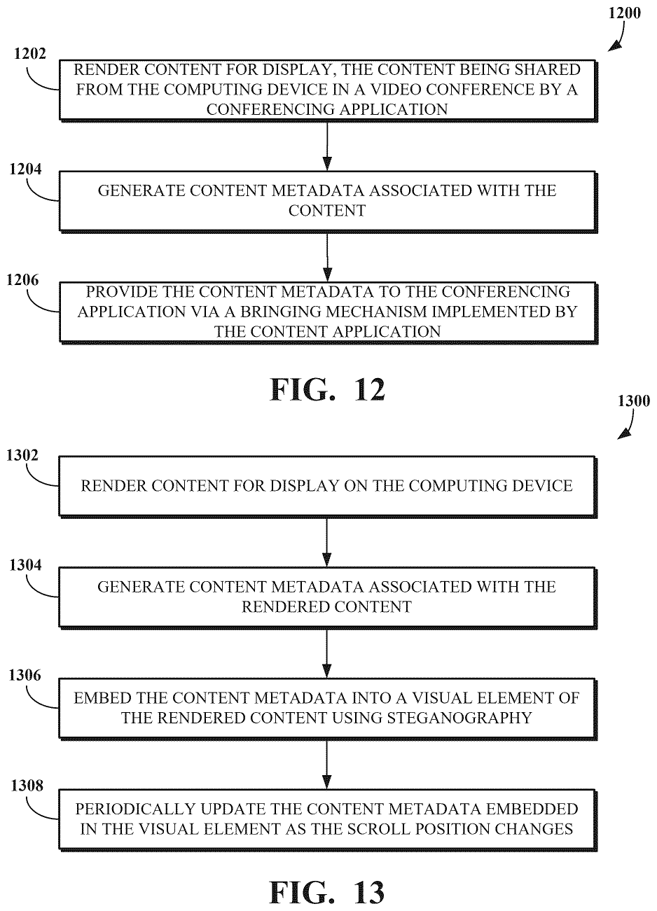

FIG. 13 is a flowchart of another example of a technique 1300 for facilitating content sharing in a video conference by rendering content and managing metadata. The technique 1300 can be executed using computing devices, such as the systems, hardware, and software described with respect to FIGS. 1-8B. The technique 1300 can be implemented at or by a presenting device, such as one of the presenting device 504 of FIG. 5.

At 1302, the technique 1300 includes rendering content for display on the computing device. The content can be a cloud-hosted document being shared in the video conference. For example, a presenting device (e.g., the presenting device 504 shown in FIG. 5) may render a document 514 retrieved from a document service 516 for sharing during a video conference. The document may be accessed via a URL, with the content application managing the document's presentation including parameters such as scroll position, zoom level, or page number.

At 1304, the technique 1300 includes generating content metadata associated with the rendered content. Thus, the content metadata may include at least the URL identifying the source of the document. The content metadata can include a scroll position indicating a current view state of the document.

At 1306, the technique 1300 includes embedding the content metadata into a visual element of the rendered content. The content metadata can be embedded using steganography. The conferencing application implemented on the computing device captures a screenshot of the rendered content, extracts the content metadata from the screenshot, and transmits the content metadata in a data packet to a receiving conferencing application during the video conference. In some implementations, the screenshot capture and extraction process may be optimized by focusing only on the visual element.

At 1308, the technique 1300 includes periodically updating the content metadata embedded in the visual element as the scroll position changes. The updated content metadata enables the receiving conferencing application to locally retrieve and render the document at the current scroll position, ensuring real-time synchronization without requiring a high-bandwidth video stream of the content. In some implementations, the periodic updates may occur at fixed intervals to balance responsiveness with processing efficiency. In some implementations, the periodic updates may occur at variable intervals based on network conditions, or the updates may be triggered by specific user actions, such as zooming, to enhance synchronization efficiency.

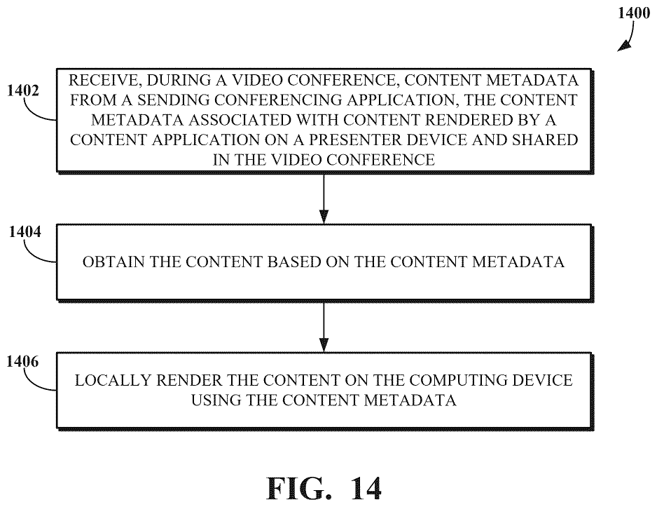

FIG. 14 is a flowchart of an example of a technique 1400 for local rendering of shared content in a video conference based on received metadata. The technique 1400 can be executed using computing devices, such as the systems, hardware, and software described with respect to FIGS. 1-8B. The technique 1400 can be implemented at or by a viewing device, such as one of the viewing device 506 of FIG. 5.

At 1402, the technique 1400 includes receiving, during a video conference, content metadata from a sending conferencing application. As described herein, the content metadata is associated with content rendered by a content application on a presenter device and shared in the video conference. For example, a receiving conferencing application (e.g., the receiving conferencing application 512 shown in FIG. 5) may receive content metadata 522 from a conferencing application 510 operating on a presenting device 504. In some implementations, the receiving of content metadata may be initiated in response to detecting a degradation in network conditions affecting a video stream from the sending conferencing application, with the receiving conferencing application requesting the content metadata from the sending conferencing application in response to the detected degradation.

At 1404, the technique 1400 includes obtaining the content based on the content metadata. For example, the receiving conferencing application 512 shown in FIG. 5 may obtain the document 514 from the document service 516 using information contained in the received metadata. As described herein, the content metadata may include a URL identifying a source of the content. Accordingly, obtaining the content may include retrieving the content from the URL. The content can be, amongst others, a word processing document, a whiteboard, or a slideshow presentation hosted in a cloud-based system.

In some implementations, obtaining the content may involve parsing the content metadata to extract a source location and a view state of the content. The content is then obtained based on the source location; and rendering the content is based on the view state. This parsing process enables the receiving conferencing application to separate the information needed to retrieve the content from the information needed to synchronize its display with the presenter's view. In some implementations, obtaining the content may include opening the content in a read-only mode on the computing device, preventing unintended modifications while allowing viewing participants to review the shared material.

In some cases, the user of the receiving conferencing application (e.g., the viewing participant) may lack permission to access the content. In such implementations, the technique 1400 may include determining that a user of the receiving conferencing application lacks permission to access the content, and transmitting a permission request to the sending conferencing application. For example, when the receiving conferencing application 512 attempts to retrieve the document 514 from the document service 516, it may encounter access restrictions requiring additional permissions. In these cases, obtaining the content may include receiving access authorization from the sending conferencing application in response to the permission request. This authorization process ensures that content sharing respects access control restrictions while enabling collaborative viewing during the video conference.

In certain implementations, the technique 1400 may include receiving temporary read permission for the content from the sending conferencing application. The temporary read permission may be configured to expire at an end of the video conference. This temporary permission mechanism allows viewing participants to access shared content during the conference without granting permanent access rights. As a follow-up action, the technique may include closing the locally rendered content upon expiration of the temporary read permission, ensuring that access limitations are enforced when the sharing context ends.

At 1406, the technique 1400 includes locally rendering the content on the computing device using the content metadata. For example, the receiving conferencing application 512 shown in FIG. 5 may instruct the local rendering application 524 to display the document 514 with view parameters specified in the content metadata 522. In some implementations, locally rendering the content may include displaying the content in a separate application window from a video conference interface of the receiving conferencing application.

In implementations where the content metadata includes specific view state information, the rendering process may incorporate these parameters to match the presenter's display. For instance, where the content metadata includes a scroll position, rendering the content locally may include scrolling the content to the scroll position specified by the content metadata. Similarly, when the content metadata includes a document identifier and a zoom level, locally rendering the content may include adjusting a display of the content to the zoom level specified by the content metadata. These view state synchronization capabilities ensure that the viewing participant sees the same portion and perspective of the content as the presenter, enhancing the collaborative experience.

The technique 1400 may include maintaining synchronization with the presenter's view throughout the sharing session. For example, the technique may include periodically receiving updated content metadata from the sending conferencing application during the video conference. Following receipt of these updates, the technique 1400 may include updating local rendering of the content based on the updated content metadata to maintain synchronization with the presenter device. This synchronization process ensures that as the presenter navigates through the content, viewing participants' displays automatically update to follow along.

In implementations where the content metadata includes scroll position information, the synchronization process may involve receiving updated content metadata including an updated scroll position, and adjusting local rendering of the content to the updated scroll position. This specific handling of scroll position updates allows for smooth tracking of the presenter's navigation through scrollable content, maintaining a consistent shared viewing experience regardless of document length or viewing device characteristics.

In some implementations, the technique 1400 may include additional features to enhance the viewing experience. For example, the receiving conferencing application may provide visual indicators showing which portions of the content the presenter is focusing on, potentially highlighting cursor positions or active selection ranges. The local rendering may support different display modes depending on the viewing device's capabilities, potentially optimizing layout for mobile devices or large-screen displays. Additionally, the technique may include options for viewing participants to temporarily detach from the presenter's view to explore different parts of the content independently, with the ability to quickly resynchronize when desired.

The techniques 900 through 1400 of FIGS. 9 through 14, respectively, can each be performed, for example, by executing a respective machine-readable program or other computer-executable instructions, such as routines, instructions, programs, or other code. The steps, or operations, of these techniques, or another technique, method, process, or algorithm described in connection with the implementations disclosed herein can be implemented directly in hardware, firmware, software executed by hardware, circuitry, or a combination thereof.

For simplicity of explanation, techniques 900 through 1400 is each depicted and described herein as a respective series of steps or operations. However, the steps or operations of each of these techniques in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Some implementations are described below as numbered examples (Example A, B, C, etc.). These examples are provided as examples only and do not limit the other implementations disclosed herein.

Example A is a method performed by a remote conferencing application implemented on a computing device, the method including receiving, during a video conference, content metadata from a sending conferencing application, the content metadata associated with content rendered by a content application on a presenter device and shared in the video conference; obtaining the content based on the content metadata; and locally rendering the content on the computing device using the content metadata.

Example B is the method of Example A further including determining that a user of the receiving conferencing application lacks permission to access the content; and transmitting a permission request to the sending conferencing application.

Example C is the method of Example B where obtaining the content includes receiving access authorization from the sending conferencing application in response to the permission request.

Example D is the method of Example A further including periodically receiving updated content metadata from the sending conferencing application during the video conference.

Example E is the method of Example D further including updating local rendering of the content based on the updated content metadata to maintain synchronization with the presenter device.

Example F is the method of Example A where the content metadata includes a scroll position, and where rendering the content locally includes scrolling the content to the scroll position specified by the content metadata.

Example G is the method of Example F further including receiving updated content metadata including an updated scroll position; and adjusting local rendering of the content to the updated scroll position.

Example H is the method of Example A further including receiving a temporary read permission for the content from the sending conferencing application, where the temporary read permission expires at an end of the video conference.

Example I is the method of Example H further including closing the locally rendered content upon expiration of the temporary read permission.

Example J is a computing device that implements a receiving conferencing application, including a memory subsystem; and processing circuitry, the processing circuitry configured to execute instructions stored in the memory subsystem to: receive, during a video conference, content metadata from a sending conferencing application, the content metadata associated with content rendered by a content application on a presenter device and shared in the video conference; obtain the content based on the content metadata; and locally render the content on the computing device using the content metadata.

Example K is the computing device of Example J where to obtain the content, the processing circuitry is configured to execute instructions stored in the memory subsystem to: open the content in a read-only mode on the computing device.

Example L is the computing device of Example J where the content metadata includes a uniform resource locator (URL) identifying a source of the content, and to obtain the content, the processing circuitry is configured to execute instructions stored in the memory subsystem to: retrieve the content from the URL.

Example M is the computing device of Example J where the processing circuitry is further configured to execute instructions stored in the memory subsystem to: detect a degradation in network conditions affecting a video stream from the sending conferencing application; and request the content metadata from the sending conferencing application in response to the detected degradation.

Example N is the computing device of Example J where the content includes at least one of a document, a whiteboard, or a slideshow presentation hosted in a cloud-based system.

Example O is the computing device of Example J where to locally render the content, the processing circuitry is configured to execute instructions stored in the memory subsystem to: display the content in a separate application window from a video conference interface of the receiving conferencing application.

Example P is one or more non-transitory computer readable media storing instructions operable to cause one or more processors to perform operations of a receiving conferencing application implemented on a computing device, the operations including receiving, during a video conference, content metadata from a sending conferencing application, the content metadata associated with content rendered by a content application on a presenter device and shared in the video conference; obtaining the content based on the content metadata; and locally rendering the content on the computing device using the content metadata.

Example Q is the one or more non-transitory computer readable media of Example P where the operations further include parsing the content metadata to extract a source location and a view state of the content, and where the content is obtained based on the source location, and rendering the content is based on the view state.

Example R is the one or more non-transitory computer readable media of Example P where the content metadata includes a document identifier and a zoom level, and locally rendering the content includes adjusting a display of the content to the zoom level specified by the content metadata.

Example S is the one or more non-transitory computer readable media of Example P where the operations further include determining that a user of the receiving conferencing application lacks permission to access the content; and transmitting a permission request to the sending conferencing application.

Example T is the one or more non-transitory computer readable media of Example S where obtaining the content includes receiving access authorization from the sending conferencing application.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, Javascript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

1. A method performed by a remote conferencing application implemented on a computing device, the method comprising:
receiving, during a video conference, content metadata from a sending conferencing application, the content metadata associated with content rendered by a content application on a presenter device and shared in the video conference;
obtaining the content based on the content metadata; and
locally rendering the content on the computing device using the content metadata.

2. The method of claim 1, further comprising:
determining that a user of the receiving conferencing application lacks permission to access the content; and
transmitting a permission request to the sending conferencing application.

3. The method of claim 2, wherein obtaining the content comprises:
receiving access authorization from the sending conferencing application in response to the permission request.

4. The method of claim 1, further comprising:
periodically receiving updated content metadata from the sending conferencing application during the video conference.

5. The method of claim 4, further comprising:
updating local rendering of the content based on the updated content metadata to maintain synchronization with the presenter device.

6. The method of claim 1,
wherein the content metadata comprises a scroll position, and
wherein rendering the content locally comprises:
scrolling the content to the scroll position specified by the content metadata.

7. The method of claim 6, further comprising:
receiving updated content metadata including an updated scroll position; and
adjusting local rendering of the content to the updated scroll position.

8. The method of claim 1, further comprising:
receiving a temporary read permission for the content from the sending conferencing application, wherein the temporary read permission expires at an end of the video conference.

9. The method of claim 8, further comprising:
closing the locally rendered content upon expiration of the temporary read permission.

10. A computing device that implements a receiving conferencing application, comprising:
a memory subsystem; and
processing circuitry, the processing circuitry configured to execute instructions stored in the memory subsystem to:
receive, during a video conference, content metadata from a sending conferencing application, the content metadata associated with content rendered by a content application on a presenter device and shared in the video conference;
obtain the content based on the content metadata; and
locally render the content on the computing device using the content metadata.

11. The computing device of claim 10, wherein to obtain the content, the processing circuitry is configured to execute instructions stored in the memory subsystem to:
open the content in a read-only mode on the computing device.

12. The computing device of claim 10, wherein the content metadata comprises a uniform resource locator (URL) identifying a source of the content, and to obtain the content, the processing circuitry is configured to execute instructions stored in the memory subsystem to:
retrieve the content from the URL.

13. The computing device of claim 10, the processing circuitry further configured to execute instructions stored in the memory subsystem to:
detect a degradation in network conditions affecting a video stream from the sending conferencing application; and
request the content metadata from the sending conferencing application in response to the detected degradation.

14. The computing device of claim 10, wherein the content comprises at least one of a document, a whiteboard, or a slideshow presentation hosted in a cloud-based system.

15. The computing device of claim 10, wherein to locally render the content, the processing circuitry is configured to execute instructions stored in the memory subsystem to:
display the content in a separate application window from a video conference interface of the receiving conferencing application.

16. One or more non-transitory computer readable media storing instructions operable to cause one or more processors to perform operations of a receiving conferencing application implemented on a computing device, the operations comprising:
receiving, during a video conference, content metadata from a sending conferencing application, the content metadata associated with content rendered by a content application on a presenter device and shared in the video conference;
obtaining the content based on the content metadata; and
locally rendering the content on the computing device using the content metadata.

17. The one or more non-transitory computer readable media of claim 16, the operations further comprising:
parsing the content metadata to extract a source location and a view state of the content, and wherein the content is obtained based on the source location, and rendering the content is based on the view state.

18. The one or more non-transitory computer readable media of claim 16, wherein the content metadata includes a document identifier and a zoom level, and locally rendering the content comprises:
adjusting a display of the content to the zoom level specified by the content metadata.

19. The one or more non-transitory computer readable media of claim 16, the operations further comprising:
determining that a user of the receiving conferencing application lacks permission to access the content; and
transmitting a permission request to the sending conferencing application.

20. The one or more non-transitory computer readable media of claim 19, wherein obtaining the content comprises:
receiving access authorization from the sending conferencing application.
